(19) United States
(12) Patent Application Publication
(10) Pub. No.: US 2006/0219180 A1
(43) Pub. Date: Oct. 5, 2006

(54) Set of teatcups, and a milking member

(76) Inventor: Jan Kassibrahim, Norsborg (SE)

Correspondence Address: HOVEY WILLIAMS LLP, 2405 GRAND BLVD., SUITE 400, KANSAS CITY, MO, 64108, US

(21) Appl. No.: 10/550,983

(22) PCT Filed: Mar. 22, 2004
(86) PCT No.: PCT/SE04/00424

§ 371 Date: Sep. 26, 2005

(30) Foreign Application Priority Data
Mar. 28, 2003 (SE) 0300892-7

(51) Int. Cl. A01J 5/04

(52) U.S. Cl. 119/14.51

(57) ABSTRACT

The invention refers to a set of four teatcup liners (4, 5) and to a milking member. The milking member includes a claw (1) and four teatcups (2) to be attached to a respective teat of an animal to be milked. Each teatcup liner has a liner portion adapted to be received in one of the teacups and a conduit portion (9) adapted to extend between the respective teatcup and the claw. The conduit portion of each teatcup liner has at least one property influencing the operation of the teatcup liner during milking. The property of a first pair or the four teatcup liners differs from the property of a second pair of the four teatcup liners.

### BACKGROUND OF THE INVENTION AND PRIOR ART

The present invention refers to a set of a four of teatcup liners for a milking member including a claw and four teatcups to be attached to a respective teat of an animal to be milked, each teatcup liner having a liner portion adapted to be comprised in one of said teatcups and a conduit portion adapted to extend between the respective teatcup and the claw, wherein the conduit portion of each teatcup liner has at least one property influencing the operation of the teatcup liner during milking. The present invention also refers to a milking member including a claw, four teatcups and a set of a four of teatcup liners, each teatcup liner having a liner portion comprised in one of said teatcups and a conduit portion extending between the respective teatcup and the claw, wherein the conduit portion of each teatcup liner has at least one property influencing the operation of the teatcup liner during milking. Such a set and such a milking member is disclosed in U.S. Pat. No. 6,058,880.

The positions of the teats of the udder of cows is in the most cases asymmetric or irregular. For instance, the distance between the two front teats is normally longer than the distance between the two rear teats. An investigation from 1983 discloses an average distance between the front teats of 150 mm, between the rear teats of 85 mm and between the rear and front teats of 100 mm. Furthermore, the front udder half is usually higher than the rear one, i.e. the two front teats are usually located at a higher position than the two rear teats. Moreover, when the udders are filled with milk the teats are relatively stiff and straggling. Therefore, the teats will be relatively immovable in relation to these positions.

This situation makes it difficult to attach teatcups configured in a conventional manner to the teats of the cow, since the teatcups do not reach the teats properly. It may therefore be difficult to attach teatcups in such a manner that they close tightly against the teat. If the teatcup liner does not close tightly against the teat, there may be a significant air inlet between the teatcup liner and the teat, which may not be controlled. This deficiency makes the milking less effective and requires a higher capacity of the vacuum pump, which in certain situations can lead to detachment of the teatcups before the milking has been terminated. There is also a restricting requirement regarding the length of the conduit portions of the teatcup liners. If the conduit portions are too long, the claw will touch the ground or the floor, at least during the end of the milking. The problems mentioned above have become worse in recent time, since the short milk conduit has become thicker and thus stiffer in order to be able to conduct an increasing milk flow. Furthermore, it has been difficult to provide a close connection between the short milk conduit and the housing of the claw due to the bending forces acting on the milk conduit. Because of this, air tends to penetrate the inner space of the housing between the short milk conduit and the inlet opening.

U.S. Pat. No. 6,058,880 discloses a milking member including a claw, four teatcups and a set of a four of teatcup liners. Each teatcup liner has a liner portion to be comprised in one of said teatcups and a conduit portion extending between the respective teatcup and the claw. The conduit portion of each teatcup liner is substantially identical to the conduit portion of the remaining teatcup liners. This document recognises the problem caused by the irregularity of the udder. In this document it is proposed to solve this problem by providing the claw with an asymmetrical shape. The distance between the forward inlet members is longer than the distance between the rear inlet members. Moreover, the forward inlet members are provided at a higher position than the rear inlet members. Finally, this document also discloses that the forward inlet members has a larger angle of inclination to a vertical central axis than the rear inlet members.

DE-1 027 457 discloses a milking member including a claw with four inlet nipples. The two inlet nipples intended for the forward teats of the animal have a length which is shorter than the length of the inlet nipples intended for the rear teats of the animal.

U.S. Pat. No. 631,774 discloses a milking member of a different kind. The milking member has four teatcups attached to a central member via a respective rigid milk conduit. The milk conduits extend horizontally and have a length that is adjustable by means of a telescoping mechanism.

### SUMMARY OF THE INVENTION

The object of the present invention is to provide a solution to the problems discussed above.

This object is achieved by the set of teatcup liners initially defined, which is characterised in that said property of a first pair of the four teatcup liners differs in a predetermined manner from said property of a second pair of the four teatcup liners.

By means of such a configuration of the seat of teatcup liners, it may be ensured that the teatcups in a better way than previously reach their respective teats properly. The engagement or the grip between the teatcup liners and their respective teats may be improved, reducing the risk for air leakage. Furthermore, the tensions in the conduit portion may decrease and the claw will be suspended in more natural manner beneath the animal. In addition, such a configuration may also result in an equal, downwardly directed force, acting at each teat, for all four teats. Consequently, an equal and proper milk extraction of each teat may be guaranteed.

Moreover, these advantages may be achieved by the use of a conventional claw being symmetrical with regard to the position, shape an design of the milk inlet members.

According to an embodiment of the present invention, the first pair of said teatcup liners is adapted to be attached to the rear teats of the animal and the second pair of said teatcup liners is adapted to be attached to the forward teats of the animal.

According to a further embodiment of the present invention, said property includes at least one of the length of the conduit portion, the flexibility of the conduit portion and the straightness of the conduit portion. These properties significally influence the operation of the milking member during the milking of the animal.

According to a further embodiment or the present invention, said property includes the length of the conduit portion, wherein the length of the first pair differs from the length of the second pair by a predetermined distance. By such a design, the claw will hang down in natural way beneath the udder without sloping in any direction. Preferably, the predetermined distance corresponds to the length difference between the rear teats and the forward teats of the animal, wherein the length of the first pair may be shorter than the length of the second pair.

According to a further embodiment of the present invention said property includes the flexibility of the conduit portion, wherein the flexibility of the first pair differs from the flexibility of the second pair by a predetermined value. Such a differing flexibility is advantageous when the teats of one pair of teats are directed outwardly, since the differing flexibility permits all the teatcups to be tightly attached to the respective teat. Advantageously, the flexibility of the first pair is higher than the flexibility of the second pair.

According to a further embodiment of the present invention, said property includes the straightness of the conduit portion, wherein the straightness of the first pair differs from the straightness of the second pair by a predetermined value. By such a pre-formed modification of the straightness of the conduit portion, the attachment of the milking member to the teats may be adapted in a better way to the shape of the udder. Preferably, the straightness of the first pair is higher than the straightness of the second pair. Furthermore, each conduit portion of the first pair of teatcups liners may advantageously have a slightly S-like curvature in such a way that the distance between the conduit portions at the upper end in the proximity of the teatcup is shorter than at the lower end in the proximity of the claw.

According to a further embodiment of the present invention, each teatcup liner is one moulded piece. By moulding the teatcup liner in one single piece of material, the liner may be manufactured in an easy and convenient manner. A pre-formed straightness, e.g. a non-straight extension of the conduit portion, may easily be achieved by such a manufacturing method.

According to a further embodiment of the present invention, the set includes a member for keeping the teatcup liners together prior to the mounting of the liners in the milking member.

The object is also achieved by the milking member initially defined, which is characterised in that said property of a first pair of the four teatcup liners differs in a predetermined manner from said property of a second pair of the four teatcup liners. Preferred embodiments of the milking member are defined in claims 15 to 25.

### BRIEF DESCRIPTION OF THE DRAWINGS

The present invention will now be described more closely by means of various embodiments thereof and with reference to the drawings attached hereto.

FIG. 1 shows schematically a view of a set of teatcups liners according to a first embodiment of the present invention.

FIG. 2 shows schematically a view of a set of teatcup liners according to a second embodiment of the present invention.

FIG. 3 shows schematically a view of a milking member according to the present invention.

FIG. 4 discloses schematically a view from above of a holding member for holding the set of teatcup liners.

### DETAILED DESCRIPTION OF VARIOUS EMBODIMENTS OF THE PRESENT INVENTION

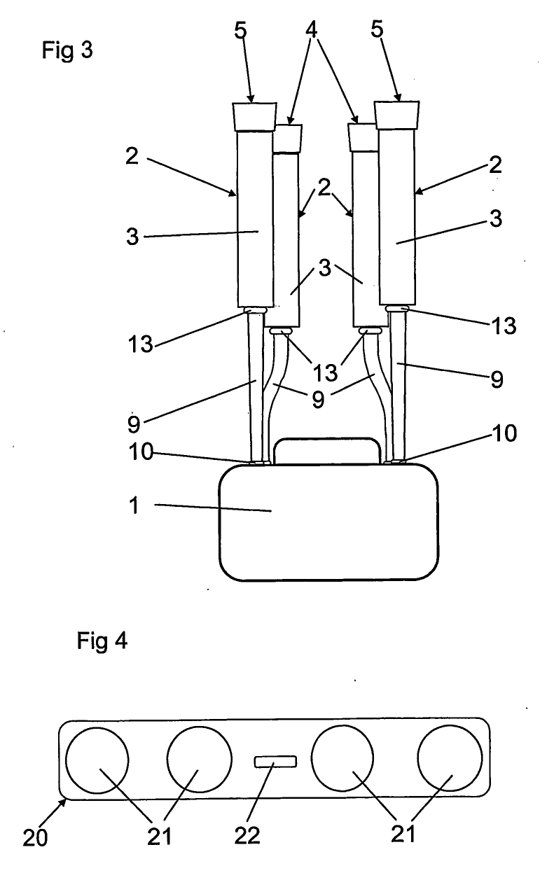

FIG. 3 discloses a milking member for the milking of an animal, e.g. a cow. The milking member includes a claw 1 and four teatcups 2. Each teatcup 2 includes a teatcup shell 3 and a teatcup liner 4, 5. The claw 1 may be of any conventional type, which has a housing forming an inner space for collecting the milk from each of the teatcups 2. The teatcup liners includes two pairs of teatcup liners 4, 5, a first pair of teatcup liners 4 and a second pair of teatcup liners 5. In the embodiments disclosed, the first pair of the teatcup liners 4 is adapted to be attached to the rear teats of the animal to be milked, and the second pair of said teatcup liners 5 is adapted to be attached to the forward teats of the animal.

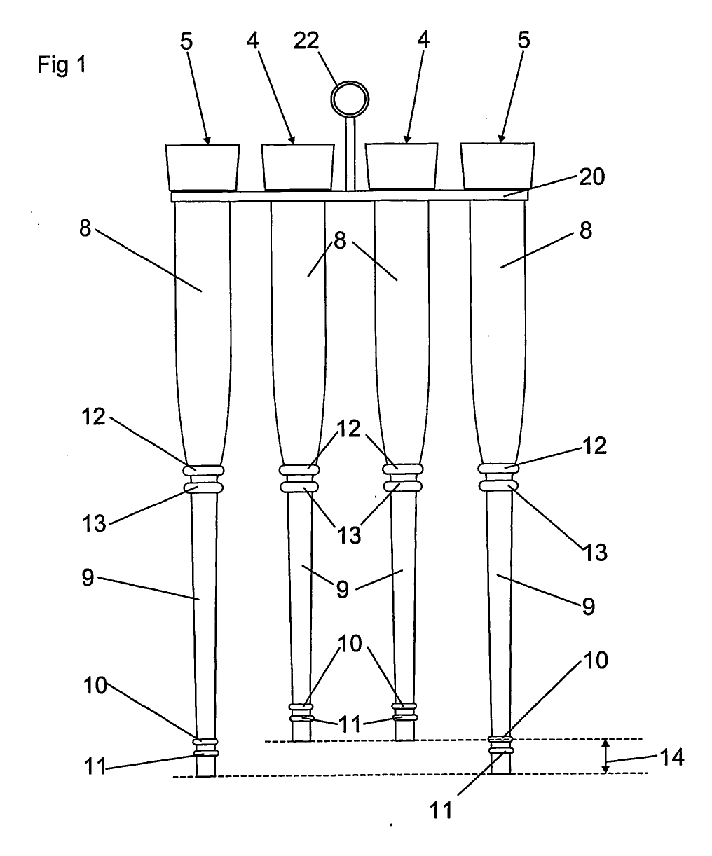

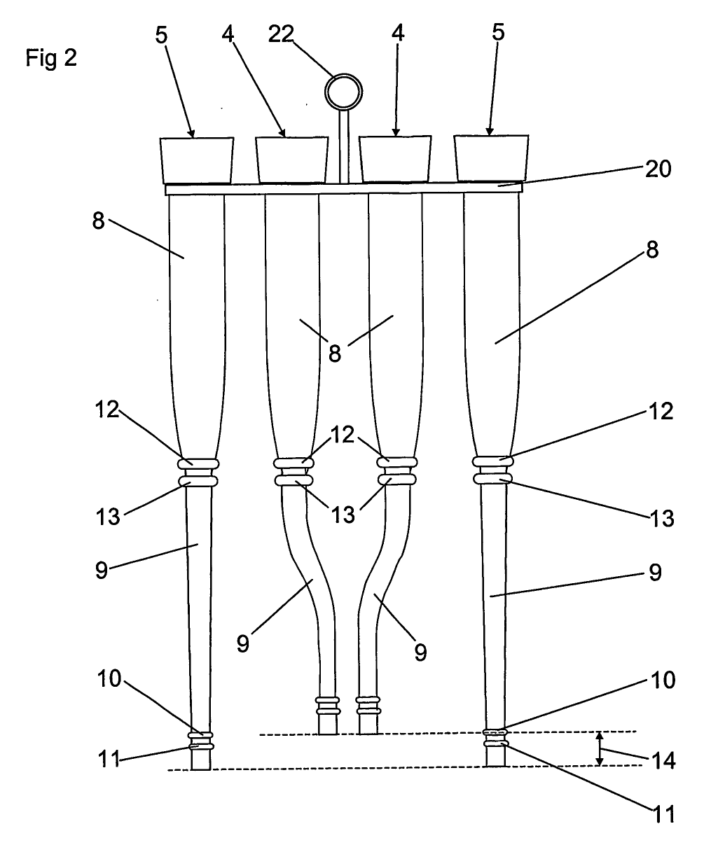

Each teatcup liner 4, 5 is moulded in one piece of a rubber material to have a pre-formed shape. Each teatcup liner 4, 5 has a liner portion 8 and a conduit portion 9, see FIGS. 1 and 2. The liner portion 8 is comprised in a respective one of said teatcups 2, and more precisely introduced in a respective one of the teatcup shells 3. When the teatcup 2 is attached to a teat of an animal to be milked, the teat is introduced into the interior of the liner portion 8 of the teatcup liner 4, 5. The conduit portion 9 extends between the liner portion 8 and the claw 1. The conduit portion 9 thus has an upper end in the proximity of or adjoining the liner portion 8, and a lower end. The lower end is connected to an inlet member of the claw 1.

In the embodiments disclosed, see FIG. 3, the inlet member is formed by an aperture through the housing of the claw 1, wherein the lower end of the conduit portion 9 is introduced into the aperture. The lower end includes two ribs 10, 11 extending around the conduit portion 9. The ribs 10, 11 are positioned at a distance from each other. When the lower end of the conduit portion 9 is introduced in the aperture of the claw 1, one of the ribs 10 will abut the upper surface surrounding the aperture and the other rib 11 will abut the lower surface surrounding the aperture. It is to be noted that the inlet members also may be formed by tubular inlet nipples extending from the claw 1, wherein each inlet nipple is introduced into the lower end of the respective conduit portion 9.

Furthermore, each teatcup liner 4, 5 in the proximity of the upper end of the conduit portion 9 includes two ribs 12, 13 extending around the conduit portion 9. The ribs 12, 13 are positioned at a distance from each other. When the teatcup liner 4, 5 is introduced in the respective teatcup shell 3, the conduit portion 9 will extend through an opening in the lower part of the teatcup shell 3, wherein one of the ribs 12 will abut an upper surface surrounding the opening and the other rib 13 will abut the lower surface surrounding the opening.

The conduit portion 9 of each teatcup liner 4, 5 has at least one property influencing the operation of the teatcup liner 4, 5 during milking in a significant manner. More precisely, three different properties are exemplified in this application. In order to achieve an improved functioning of the milking member one, two or all of these properties are varied in a predetermined manner for the different teatcup liners 4, 5 in the set of liners to co-operate with the claw 1. In particular, said property of a first pair 8 of the four teatcup liners differs in a predetermined manner from said property of a second pair of the four teatcup liners 4, 5.

According to a first embodiment, disclosed in FIG. 1, said property refers to the length of the conduit portion 9, i.e. the length of one of said pairs differs from the length of the other of said pair by a predetermined distance 14. In particular, the length of the first pair of teatcup liners 4 to be attached to the rear teats is shorter than the length of the second pair of teatcup liners 5 to be attached to the forward teats. Since the rear teats normally are lower than the forward teats, this embodiment permits the claw 1 to hang down properly, i.e. without sloping in any direction. Preferably, the predetermined distance 14 corresponds to an average length difference between the rear teats and the forward teats of an animal, for instance a cow. For instance, the distance 14 may be at least 10 mm, at least 20 mm, at least 30 mm or at least 40 mm.

According to a second embodiment, said property refers to the flexibility of the conduit portion 9, wherein the flexibility of the first pair of teatcup liners 4 differs from the flexibility of the second pair of teatcup liners 5 by a predetermined value. In particular, the flexibility of the first pair of teatcup liners 4 to be attached to the rear teats of the animal is higher than the flexibility of the second pair of teatcup liners 5 to be attached to the forward teats of the animal.

According to a third embodiment, disclosed in FIG. 2, said property refers to the straightness of the conduit portion 9, wherein the straightness of the first pair of teatcup liners 4 differs from the straightness of the second pair of teatcup liners 5 by a predetermined value. In particular, the straightness of the second pair of teatcup liners 5 to be attached to the forward teats of the animal is higher than the straightness of the first pair of teatcup liners 4 to be attached to the rear teats of the animal. As disclosed in FIGS. 2 and 3, each conduit portion 9 of the first pair of teatcups liners 4 has a slightly S-like curvature in such a way that the distance between the conduit portions 9 of the first pair of teatcup liners 4 at the upper end adjoining the liner portion 8 in the proximity of the teatcup shell 3 is shorter than at the lower end to be connected to the claw 1. By such a non-straight extension it is possible to compensate for the shorter mutual distance between the rear teats than between the forward teats. Moreover, by such a non-straight extension it is also possible to compensate for the shorter distance between the pair of rear teats and the pair of forward teats than mutual distance between the two forward teats.

It is to be noted that the three property differences between the first pair of teatcup liners 4 and second pair of teatcup liners 5, which have been described above, may be combined with each other in all possible combinations. Thus the first pair may be shorter and more flexible than the second pair, shorter and less straight than the second pair, more flexible and less straight than the second pair, and/or shorter, more flexible and less straight than the second pair.

The four teatcup liners 4, 5 form a set of teatcup liners to be mounted in a respective teatcup shell 3 and attached to a claw 2 of a milking member. The set of teatcup liners 4, 5 may be sold and distributed to a milk farmer as one unit. In order to facilitate the distribution and the handling on the milk farm, the teatcup liners 4, 5 of the set may be kept together in a package by a member, e.g. a holding member 20. The holding member 20 disclosed has four engagement portions 21 or openings for engaging a respective one of the teatcup liners 4, 5, see also FIG. 4, and a grip portion 22.

The present invention is not limited to the embodiments disclosed and described herein, but may be varied and modified within the scope of the following claims.

1. A set comprising four of teatcup liners for a milking member including a claw and four teacups to be attached to a respective teat of an animal to be milked, each teatcup liner having a liner portion adapted to be comprised in one of said teatcups and a conduit portion adapted to extend between the respective teatcup and the claw, wherein the conduit portion of each teatcup liner has at least one property influencing the operation of the teatcup liner during milking, wherein said property of the conduit portion of a first pair of the four teatcup liners differs in a predetermined manner from said property of a second pair of the four teatcup liners, and that said property is selected from the group consisting of the length of the conduit portion, the flexibility of the conduit portion and the straightness of the conduit portion, and combinations thereof.

2. The set according to claim 1, wherein the teats of animal include rear teats and forward teats, and wherein the first pair of said teatcup liners is adapted to be attached to the rear teats of the animal and the second pair of said teatcup liners (5) is adapted to be attached to the forward teats of the animal.

3. The set according to claim 1, wherein said property includes the length of the conduit portion, wherein the length of the first pair differs from the length of the second pair by a predetermined distance.

4. The set according to claim 3, wherein the teats of the animal include rear teats and forward teats, and wherein the predetermined distance corresponds to the length difference between the rear teats and the forward teats of the animal.

5. The set according to claim 4, wherein the length of the first pair is shorter than the length of the second pair.

6. The set according to claim 1, wherein said property includes the flexibility of the conduit portion, wherein the flexibility of the first pair differs from the flexibility of the second pair by a predetermined value.

7. The set according to claim 6, wherein the flexibility of the first pair is higher than the flexibility of the second pair.

8. The set according to claim 1, wherein said property includes the straightness of the conduit portion, wherein the straightness of the first pair differs from the straightness of the second pair by a predetermined value.

9. The set according to claim 8, wherein the straightness of the second pair is higher than the straightness of the first pair.

10. The set according to claim 9, wherein each conduit portion of the first pair of teatcups liners has a slightly S-like curvature in such a way that the distance between the conduit portions (9) at the upper end in the proximity of the teatcup is shorter than at the lower end in the proximity of the claw.

11. The set according to claim 1, wherein each teatcup liner is one moulded piece.

12. The set according to claim 1, wherein the set includes a member for keeping the teatcup liners together prior to the mounting of the liners in the milking member.

13. A milking member comprising a claw, four teatcups and a set of a four of teatcup liners, each teatcup liner having a liner portion comprised in one of said teatcups and a conduit portion extending between the respective teatcup and the claw, wherein the conduit portion of each teatcup has at least one property influencing the operation of the teatcup liner during milking, wherein said property of a first pair of the four teatcup liners differs in a predetermined manner from said property of a second pair of the four teatcup liners, and that said property is selected from the group consisting of the length of the conduit portion, the flexibility of the conduit portion and the straightness of the conduit portion, and combinations thereof.

14. The milking member according to claim 13, wherein the teats of the animal include rear teats and forward teats, and wherein the first pair of said teatcup liners is adapted to be attached to the rear teats of the animal and the second pair of said teatcup liners is adapted to be attached to the forward teats of the animal.

15. The milking member according to claim 13, wherein said property includes the length of the conduit portion, and wherein the length of the first pair differs from the length of the second pair by a predetermined distance.

16. The milking member according to claim 15, wherein the teats of the animal include rear teats and forward teats and wherein the predetermined distance corresponds to the length difference between the rear teats and the forward teats of the animal.

17. The milking member according to claim 16, wherein the length of the first pair is shorter than the length of the second pair.

18. The milking member claim 13, wherein characterised in that said property includes the flexibility of the conduit portion, wherein the flexibility of the first pair is higher than the flexibility of the second pair.

20. The milking member according to claim 13, wherein said property includes the straightness of the conduit portion, wherein the straightness of the first pair differs from the straightness of the second pair by a predetermined value.

21. The milking member according to claim 20, wherein the straightness of the second pair is higher than the straightness of the first pair.

22. The milking member according to claim 21, wherein each conduit portion of the first pair of teatcups liners (4) has a slightly S-like curvature in such a way that the distance between the conduit portions (9) at the upper end in the proximity of the teatcups (2) is shorter than at the lower end in the proximity of the claw (1).

23. The milking member according to wherein each teatcup liner (4, 5) is one moulded piece.
